(19) United States
(12) Patent Application Publication
(10) Pub. No.: US 2025/0014814 A1
(43) Pub. Date: Jan. 9, 2025

(54) INDUCTIVE COMPONENT, PREPARATION METHOD THEREFOR AND APPLICATION THEREOF

(71) Applicant: HENGDIAN GROUP DMEGC MAGNETICS CO., LTD, Dongyang City Jinhua, Zhejiang (CN)

(72) Inventors: Shengqi CHEN, Dongyang City Jinhua, Zhejiang (CN); Haifei LOU, Dongyang City Jinhua, Zhejiang (CN); Zhanfan JIN, Dongyang City Jinhua, Zhejiang (CN); Jianghao HU, Dongyang City Jinhua, Zhejiang (CN)

(21) Appl. No.: 18/546,966

(22) PCT Filed: Mar. 30, 2023
(86) PCT No.: PCT/CN2023/085018

§ 371 Date: Aug. 17, 2023

(30) Foreign Application Priority Data
Nov. 10, 2022 (CN) 202211405704.8

(51) Int. Cl. H01F 41/02; B22F 1/00; B22F 1/052; B22F 1/103; B22F 3/02; B22F 3/24; B22F 9/04; C22C 45/00; H01F 1/153

(52) U.S. Cl. CPC H01F 41/0246; B22F 1/052; B22F 1/09; B22F 1/103; B22F 3/02; B22F 3/24; B22F 9/04; C22C 45/008; H01F 1/1535; B22F 2003/242; B22F 2003/248; B22F 2201/10; B22F 2301/35; B22F 2304/10; B22F 2998/10; B22F 2999/00; C22C 2200/02; C22C 2202/02

(57) ABSTRACT

Disclosed are an inductive component and a preparation method therefor and an application thereof. The preparation method comprises the following steps: (1) mixing and granulating a first magnetic alloy powder, a second magnetic alloy powder, and a binder, and then performing pressing, and baking and curing the pressed blank to obtain a magnetic central core; (2) combining the magnetic central core obtained in step (1) with a coil and placing into a mold cavity, injecting a cladding powder slurry, and then baking to obtain a semi-finished component; and (3) coating an insulation layer on the surface of the semi-finished component obtained in step (2), performing paint stripping, and then performing electroplating to form an electrode layer to obtain the inductive component. By performing the low-pressure forming process, the inductive component provided by the present application has the advantages of low basic pressure between the coil and the powder, small change of the DC impedance of the coil and small internal stress of the powder, solving the problems of high interlayer defect rate and interlayer short circuit of the products caused by serious insulation damage of the powder under high pressure in the existing process.

### TECHNICAL FIELD

The present application relates to the field of inductive technology, for example, an inductive component, a preparation method therefor and an application thereof.

### BACKGROUND

With the rapid development of the global electronics industry, inductor, as one of the basic electronic components essential to the industry advance, is constantly innovating and rapidly upgrading in both application and product performance and quality, in which the one-piece molding inductors play an important role. Compared with the traditional magnetic-resin inductors, one-piece compression molding inductors are upgraded products from wire-wound inductors, which are mainly used for power supply conversion. The one-piece compression molding inductors have the advantages of high current resistance, stable electromagnetic properties, stable temperature rise, low acoustic noise, low radiation noise, impact resistance, etc. They can be applied to many fields such as mobile phones, automobiles, aviation, communications, etc., and also widely recognized in the DC-DC (direct current to direct current) power management unit (PMU) of lightweight intelligent mobile terminals, which have been widely used.

CN202183292U discloses an improved one-piece inductor, in which the coil needs to be spot-welded to the terminal wire frame, and the spot welding will lead to the increased DC impedance of the product. When the size of the coil and the terminal is small, it will be difficult to align and spot-weld the coil and the terminal, and thus the manufacturing process will have multiplied difficulty and cost, being hard to implement. At present, it is known that this process can achieve mass production of 2012 model and the pass-yield of spot welding is less than 70%. In addition, the coil and the powder are formed by compression molding, the coil will be deformed during the molding process, and the DC impedance of the coil will be significantly increased, and the insulation layer of the coil will be damaged by the extrusion of the powder during the molding process. At the same time, during the molding process of the powder, the powder particles will be forced by each other and deform, and the insulation layers coated on the particle surface will be damaged to varying degrees, resulting in poor insulation between the coil and the powder. Due to differences in the processes, the soft magnetic powders have significant differences in powder characteristics such as morphology, hardness, and particle size. Different powders may have poor formability and high internal stress when gradated, and the pressing density, and the powder interior and product will have cracks in varying degrees and other defects, and the reliability of the product is poor.

CN108648901A discloses an electronic component and a manufacturing method for an inductor which adopts the T-core process. The T-core is first pressed, and then a wire is wrapped on the T-core, and processes such as hot pressing, rolling spraying, and electrode laser paint stripping are performed to obtain the inductor. This process focuses on three processes: cold pressing the T-core, wire wrapping and hot pressing. As the wire needs to be wrapped on the T-core, the wire wrapping requires some hot air (to ensure that the coil will not be loose when wrapped) and wire wrapping tension, and thus the cold pressed T-core is required to have a certain strength, and the higher the strength, the easier it is to wrap, so wire wrapping requires that the cold pressed T-core should have strength as high as possible. The hot pressing is very similar to the one-piece molded inductor in CN202183292U, in which a combination of the wrapped T-core and the coil is placed in a mold cavity, heated on a heating platform for a certain period, and then molded in the mold cavity. In this condition, the T-core needs a certain amount of deformation to achieve the effect of secondary curing. If the strength or density of cold-pressed T-core is too high, the secondary pressing effect cannot be achieved by hot pressing, and the T-core powder and the hot-pressed powder cannot be well combined, and interface cracks or internal combination cracks will be easily generated. It can be seen that the wire wrapping process and hot pressing process has opposite requirements to the cold pressing, and the manufacture process has to take compromise conditions. In view of the compression molding process, the influences of increased impedance resulted from coil deformation and poor insulation resulted from powder compression mentioned in CN202183292U still exist, resulting in insufficient product quality. In addition, when the product size becomes smaller, such as less than 1.0 mm², the manufacturing process will face great challenge and have high requirements for materials and equipment, high cost and low yield. At present, this process is difficult to achieve a batch process.

### SUMMARY

The following is a summary of the subject described herein. This summary is not intended to limit the scope of protection of the claims.

An example of the present application provides an inductive component, a preparation method therefor and an application thereof. The inductive component of the present application is formed by a low-pressure forming process, and the basic pressure between the coil and the powder is very low (≤0.5 T/cm²), the change in the DC impedance of the coil is small, and the internal stress of the powder is small, thus solving the problems of high interlayer defect rate and interlayer short circuit of products caused by serious insulation damage of the powder under high pressure in the existing process.

In a first aspect, an example of the present application provides a preparation method for an inductive component, which includes the following steps:
(1) mixing and granulating a first magnetic alloy powder, a second magnetic alloy powder, and a binder, and then performing pressing, and baking and curing the pressed blank to obtain a magnetic central core;
(2) combining the magnetic central core obtained in step (1) with a coil and placing into a mold cavity, injecting a cladding powder slurry, and then baking to obtain a semi-finished component; and
(3) coating an insulation layer on the surface of the semi-finished component obtained in step (2), performing paint stripping, and then performing electroplating to form an electrode layer to obtain the inductive component.

In the preparation process of the inductive component in the present application, the magnetic central core is formed by cold press molding followed by low-temperature sintering. The sintered magnetic central core has superior magnetic properties and strength, especially the low internal stress of the magnetic material (low-temperature sintering has a stress relieving effect), which reduces the DC impedance of the product and improves the working current of the product.

The coil, the magnetic central core, and the external magnetic cladding material of the coil in the inductive component in the present application are all processed by independent process, which solves the large deformation problem of inductive coils for the existing one-piece molding, redces large DC impedance of the product, and improves the working current, and solves the problem of difficult production of small products at the same time.

Preferably, the first magnetic alloy powder in step (1) includes an amorphous alloy powder and/or a nanocrystalline powder.

Preferably, a median particle size D50 of the first magnetic alloy powder is 20-40 μm, such as 20 μm, 25 μm, 30 μm, 35 μm or 40 μm, etc.

Preferably, the second magnetic alloy powder includes any one or a combination of at least two of an iron-nickel powder, an iron-silicon-aluminum powder, or an iron-silicon-chromium powder.

Preferably, a median particle size D50 of the second magnetic alloy powder is 1-5 μm, such as 1 μm, 2 μm, 3 μm, 4 μm or 5 μm, etc.

Preferably, a gradation ratio of the first magnetic alloy powder and the second magnetic alloy powder is 2:8-8:2, such as 2:8, 3:7, 4:6, 5:5, 6:4, 7:3 or 8:2, etc.

Preferably, the binder includes an epoxy adhesive.

Preferably, a total mass of the first magnetic alloy powder and the second magnetic alloy powder and a mass of the binder have a ratio of 100:1-3.5, such as 100:1, 100:2, 100:3 or 100:3.5, etc.

Preferably, a mesh number for the mixing and granulating in step (1) is 60-250, such as 60 mesh, 80 mesh, 100 mesh, 150 mesh or 250 mesh, etc.

Preferably, a pressure of the pressing is 3-10 T/cm², such as 3 T/cm², 5 T/cm², 7 T/cm², 8 T/cm² or 10 T/cm², etc.

Preferably, a temperature of the pressing is 20-200° C., such as 20° C., 50° C., 80° C., 100° C. or 200° C., etc.

Preferably, a time of the pressing is 1-180 s, such as 1 s, 5 s, 10 s, 50 s, 100 s or 180 s, etc.

Preferably, an atmosphere for the baking and curing in step (1) includes an inert atmosphere.

Preferably, a heating method of the baking and curing is stepped heating.

The stepped heating includes one-step heating, two-step heating, three-step heating, and four-step heating.

Preferably, a temperature after the one-step heating is 90-110° C., such as 90° C., 95° C., 100° C., 105° C. or 110° C., etc.

Preferably, an insulation time after the one-step heating is 20-40 min, such as 20 min, 25 min, 30 min, 35 min or 40 min, etc.

Preferably, a temperature after the two-step heating is 120-150° C., such as 120° C., 125° C., 130° C., 140° C. or 150° C., etc.

Preferably, an insulation time after the two-step heating is 20-40 min, such as 20 min, 25 min, 30 min, 35 min or 40 min, etc.

Preferably, a temperature after the three-step heating is 180-200° C., such as 180° C., 185° C., 190° C., 195° C. or 200° C., etc.

Preferably, an insulation time after the three-step heating is 50-70 min, such as 50 min, 55 min, 60 min, 65 min or 70 min, etc.

Preferably, a temperature after the four-step heating is 350-380° C., such as 350° C., 355° C., 360° C., 370° C. or 380° C., etc.

Preferably, an insulation time after the four-step heating is 100-140 min, such as 100 min, 110 min, 120 min, 130 min or 140 min, etc.

Preferably, a shape of the magnetic central core includes a circular shape, an elliptical shape, a square shape, a conical shape, an I-shape or a T-shape.

Preferably, a fitting gap of 0.02-0.06 mm (such as 0.02 mm, 0.03 mm, 0.04 mm, 0.05 mm, or 0.06 mm) is reserved for the magnetic central core.

Preferably, a material of the coil in step (2) includes a conductive material and an insulation layer and a self-adhesive layer arranged on the surface of the conductive material.

Preferably, the conductive material includes copper.

Preferably, the coil includes any one or a combination of at least two of a circular wire, a flat wire or a square corner wire.

Preferably, the cladding powder slurry in step (2) includes a third magnetic alloy powder, a fourth magnetic alloy powder, a dispersant, a consumable agent, an accelerator, and an organic solvent.

Preferably, the third magnetic alloy powder includes an amorphous alloy powder and/or a nanocrystalline powder.

Preferably, a median particle size D50 of the third magnetic alloy powder is 20-55 μm, such as 20 μm, 25 μm, 30 μm, 40 μm or 55 μm, etc.

Preferably, the fourth magnetic alloy powder includes any one or a combination of at least two of an iron-nickel powder, an iron-silicon-aluminum powder, or an iron-silicon-chromium powder.

Preferably, a median particle size D50 of the fourth magnetic alloy powder is 0.3-0.8 μm, such as 0.3 μm, 0.4 μm, 0.5 μm, 0.6 μm or 0.8 μm, etc.

Preferably, a gradation ratio of the third magnetic alloy powder and the fourth magnetic alloy powder is 2:8-8:2, such as 2:8, 3:7, 4:6, 5:5, 6:4, 7:3 or 8:2, etc.

Preferably, the organic solvent includes alcohol and/or toluene.

Preferably, a viscosity of the cladding powder slurry is 500-2000 Mpa·s, such as 500 Mpa·s, 800 Mpa·s, 1000 Mpa·s, 1200 Mpa·s, 1500 Mpa·s or 2000 Mpa·s, etc.

The external magnetic cladding material of the coil in the present application is processed through powder gradation, and is composed of two or more soft magnetic alloy powders in gradation. Because there is basically no pressure, the insulation of the powder is much better than that of the one-piece compression molding process.

Preferably, an injection pressure per unit area of the injecting the cladding powder slurry is less than or equal to 0.5 T/cm².

The present application adopts a low-pressure forming process, where the basic pressure between the coil and the powder is very low (≤0.5 T/cm²), the change in the DC impedance of the coil is small, and the internal stress of the powder is small, thus avoiding the high interlayer defect rate of the product caused by the serious insulation damage of the powder and solving the problem of interlayer short circuit of the product.

Preferably, a heating method of the baking in step (2) is stepped heating.

The stepped heating includes one-step heating, two-step heating and three-step heating.

Preferably, a temperature after the one-step heating is 90-110° C., such as 90° C., 95° C., 100° C., 105° C. or 110° C., etc.

Preferably, an insulation time after the one-step heating is 20-40 min, such as 20 min, 25 min, 30 min, 35 min or 40 min, etc.

Preferably, a temperature after the two-step heating is 120-150° C., such as 120° C., 125° C., 130° C., 140° C. or 150° C., etc.

Preferably, an insulation time after the two-step heating is 20-40 min, such as 20 min, 25 min, 30 min, 35 min or 40 min, etc.

Preferably, a temperature after the three-step heating is 180-200° C., such as 180° C., 185° C., 190° C., 195° C. or 200° C., etc.

Preferably, an insulation time after the three-step heating is 150-200 min, such as 50 min, 55 min, 60 min, 65 min or 70 min, etc.

The present application uses a stepped heating method to bake and cure the magnetic central core. The stepped heating curing can ensure that the solvent in the magnetic central core can be slowly evaporated and the adhesive can be cured slowly, and the product itself will not generate excessive stress and strain which can lead to cracking, pores and other defects.

Preferably, a material of the insulation layer in step (3) includes any one or a combination of at least two of an epoxy resin, polyurethane, a silicone resin, an organosilicone resin, an amino resin, a polyimide resin, a phenolic resin, a cyanate resin or an acrylic resin.

Preferably, a material of the electroplating includes any one or a combination of at least two of copper, nickel or tin.

In a second aspect, an example of the present application provides an inductive component, which is manufactured by the method in the first aspect.

In a third aspect, an example of the present application provides an application of the inductive component in the second aspect, wherein the inductive component is used in lightweight intelligent mobile terminals.

Compared with the related art, examples of the present application have the following beneficial effects.
a. The inductive component in an example of the present application adopts a low-pressure forming process, the basic pressure between the coil and the powder is very low (≤0.5 T/cm²), the change in the DC impedance of the coil is small, and the internal stress of the powder is small, thus solving the problems of high interlayer defect rate and interlayer short circuit of the products caused by serious insulation damage of the powder under high pressure in the existing process.
b. The impedance value of the inductive component prepared by the method in an example of the present application can reach less than or equal 32.18 mΩ, and the interlayer defect rate is less than or equal 50 ppm.

Other aspects will become apparent after reading and understanding the drawings and detailed description.

### BRIEF DESCRIPTION OF DRAWINGS

The accompanying drawings are used to provide a further understanding of the technical solutions herein, constitute a part of the specification, and explain the technical solutions herein together with the examples of the present application, but do not limit the technical solutions herein.

FIG. 1 is a heating curve of the baking and curing process in step (1) of Examples 1-3.

FIG. 2 is a heating curve of the baking in step (2) of Examples 1-3.

### DETAILED DESCRIPTION

The following is to further explain technical solutions of the present application by specific embodiments. It should be understood by those skilled in the art that the examples are only to help to understand the present application, and should not be regarded as a specific limitation of the present application.

### Example 1

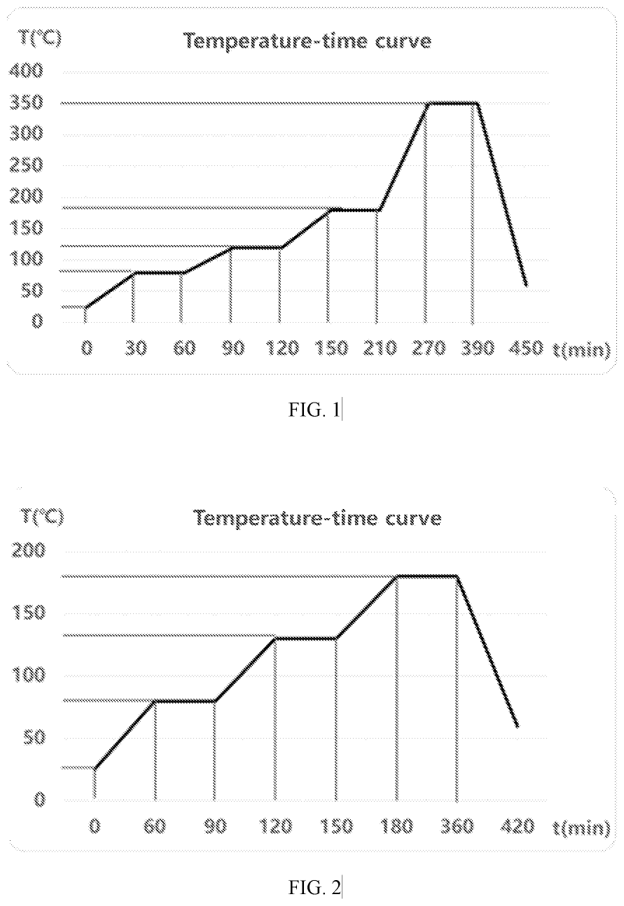

This example provides an inductive component, and a raw material composition and a preparation method of the inductive component are as follows:
raw material composition: the magnetic central core powder: an amorphous alloy powder D50=25 μm, and an iron-nickel powder D50=2.5 μm; a gradation ratio=4:6, and a content of an epoxy resin adhesive is 2.0%;
pressing conditions of the magnetic central core: a pressing temperature is 25° C., a time is 5 s, and a pressure is 5.0 T/cm²;
external cladding material of the coil: an amorphous alloy powder D50=30 μm, and an iron-based cobalt alloy powder D50=0.5 μm; a gradation ratio=6:4, a viscosity of the powder slurry is 1000 MPa·s, and an injection pressure per unit area is 0.1 T/cm²;
preparation method: (1) an amorphous alloy powder and an iron-nickel powder were weighed out in proportion, and added with a solvent and an epoxy resin adhesive and subjected to mixing and granulating to form a particle material with a certain shape, then the particle material was sieved with a 100-mesh screen, and the underneath powder was pressed into a magnetic central core, and the pressed magnetic central core was baked and cured at 360° C. for 120 min to form a round magnetic central core, and the heating curve of the baking and curing is shown in FIG. 1;
(2) the magnetic central core and a coil were assembled and placed into a mold cavity, and then an external cladding powder slurry of the coil was filled by injection, and an injection pressure per unit area was 0.1 T/cm², and then the molded blank and the mold were transferred into a furnace and baked at 180° C. for 180 min to obtain a semi-finished component, and the heating curve of the baking is shown in FIG. 2; and
(3) an epoxy resin insulation layer was sprayed onto the surface of the semi-finished component obtained in step (2), and the sprayed inductive product was subjected to paint stripping via a laser paint stripping machine to form an electrode area with a certain size and paint stripping depth, and then an electrode layer was formed by electroplating a Cu layer, a Ni layer, and a Sn layer, and the inductive component was obtained.

### Example 2

This example provides an inductive component, and a raw material composition and a preparation method of the inductive component are as follows:
raw material composition: the magnetic central core powder: an amorphous alloy powder D50=25 μm, and an iron-nickel powder D50=2.5 μm; a gradation ratio=4:6, and a content of an epoxy resin adhesive is 2.0%;
pressing conditions of the magnetic central core: a pressing temperature is 25° C., a time is 5 s, and a pressure is 5.0 T/cm²;
external cladding material of the coil: an amorphous alloy powder D50=30 μm, and an iron-based cobalt alloy powder D50=0.5 μm; a gradation ratio=6:4, a viscosity of the powder slurry is 1000 MPa·s, and an injection pressure per unit area is 0.3 T/cm²;
preparation method: (1) an amorphous alloy powder and an iron-nickel powder were weighed out in proportion, and added with a solvent and an epoxy resin adhesive and subjected to mixing and granulating to form a particle material with a certain shape, then the particle material was sieved with a 100-mesh screen, and the underneath powder was pressed into a magnetic central core, and the pressed magnetic central core was baked and cured at 360° C. for 120 min to form a round magnetic central core, and the heating curve of the baking and curing is shown in FIG. 1;
(2) the magnetic central core and a coil were assembled and placed into a mold cavity, and then an external cladding powder slurry of the coil was filled by injection, and an injection pressure per unit area was 0.3 T/cm², and then the molded blank and the mold were transferred into a furnace and baked at 180° C. for 180 min to obtain a semi-finished component, and the heating curve of the baking is shown in FIG. 2; and
(3) an epoxy resin insulation layer was sprayed onto the surface of the semi-finished component obtained in step (2), and the sprayed inductive product was subjected to paint stripping via a laser paint stripping machine to form an electrode area with a certain size and paint stripping depth, and then an electrode layer was formed by electroplating a Cu layer, a Ni layer, and a Sn layer, and the inductive component was obtained.

### Example 3

This example provides an inductive component, and a raw material composition and a preparation method of the inductive component are as follows:
raw material composition: magnetic central core powder: an amorphous alloy powder D50=25 μm, an iron-nickel powder D50=2.5 μm; a gradation ratio=4:6, and a content of an epoxy resin adhesive is 2.0%;
pressing conditions of the magnetic central core: a pressing temperature is 25° C., a time is 5 s, a pressure is 5.0 T/cm²;
external cladding material of the coil: an amorphous alloy powder D50=30 μm and an iron-based cobalt alloy powder D50=0.5 μm; a gradation ratio=6:4, a viscosity of the powder slurry is 1000 MPa·s, and an injection pressure per unit area is 0.5 T/cm²;
preparation method: (1) an amorphous alloy powder and an iron-nickel powder were weighed out in proportion, and added with a solvent and an epoxy resin adhesive and subjected to mixing and granulating to form a particle material with a certain shape, then the particle material was sieved with a 100-mesh screen, and the underneath powder was pressed into a magnetic central core, and the pressed magnetic central core was baked and cured at 360° C. for 120 min to form a round magnetic central core, and the heating curve of the baking and curing is shown in FIG. 1;
(2) the magnetic central core and a coil were assembled and placed into a mold cavity, and then an external cladding powder slurry of the coil was filled by injection, and an injection pressure per unit area was 0.5 T/cm², and then the molded blank and the mold were transferred into a furnace and baked at 180° C. for 180 min to obtain a semi-finished component, and the heating curve of the baking is shown in FIG. 2; and
(3) an epoxy resin insulation layer was sprayed onto the surface of the semi-finished component obtained in step (2), and the sprayed inductive product was subjected to paint stripping via a laser paint stripping machine to form an electrode area with a certain size and paint stripping depth, and then an electrode layer was formed by electroplating a Cu layer, a Ni layer, and a Sn layer, and the inductive component was obtained.

### Example 4

This example differs from Example 1 only in that the magnetic central core was directly baked and cured at 360° C., and other conditions and parameters are exactly the same as in Example 1.

### Example 5

This example differs from Example 1 only in that the molded blank was directly baked with the mold at 180° C., and other conditions and parameters are exactly the same as in Example 1.

### Example 6

This example differs from Example 1 only in that a baking and curing temperature was 330° C., and other conditions and parameters are exactly the same as in Example 1.

### Example 7

This example differs from Example 1 only in that a baking and curing temperature was 400° C., and other conditions and parameters are exactly the same as in Example 1.

### Comparative Example 1

The inductor in CN202183292U is used as a comparative example.

### Comparative Example 2

The inductor in CN108648901A is used as a comparative example.

### Performance Test

ADEX AX-1152D DC impedance meter was used to measure the product impedance value and Chroma 19301A was used to measure the interlayer defect of the product. The test results are shown in Table 1.

TABLE 1

| | Impedance value (mΩ) | Interlayer defect rate (ppm) |
|---|---|---|
| Example 1 | 32.1 | <50 |
| Example 2 | 32.18 | <50 |
| Example 3 | 32.15 | <50 |
| Example 4 | 32.21 | 50 < ppm < 100 |
| Example 5 | 32.13 | 50 < ppm < 100 |
| Example 6 | 32.16 | 50 < ppm < 100 |
| Example 7 | 32.19 | 50 < ppm < 100 |
| Comparative | 55.3 | >500 |
| Example 1 | | |
| Comparative | 40.9 | >200 |
| Example 2 | | |

As can be seen from Table 1, according to Examples 1-3, the impedance value of the inductive component prepared by the method in the present application can reach less than or equal to 32.18 mΩ, and the interlayer defect rate is less than or equal to 50 ppm.

As can be seen from the comparison of Example 1 and Example 4, the present application uses a stepped heating method to bake and cure the magnetic central core. The stepped heating curing can ensure that the solvent in the magnetic central core can be slowly evaporated, the adhesive can be cured slowly, and the product itself will not generate excessive stress and strain, which can lead to cracking, pores, and other defects.

As can be seen from the comparison of Example 1 and Example 5, considering the composition of the material system, the semi-finished components in the present application are baked in a stepped heating method. Low temperature and slow baking enables the residual solvents in the material to be fully evaporated, and thus the high temperature baking and curing will not lead to cracking, pores and other defects.

As can be seen from the comparison of Example 1 and Examples 6-7, the baking and curing temperature in the present application will affect the performance of the prepared inductive component. By controlling the baking and curing temperature at 350-380° C., the performance of the prepared inductive component is better. If the baking and curing temperature is too low, the stress relief annealing temperature of the material will not be reached, and the magnetic properties of the material cannot be fully utilized. If the baking and curing temperature is too high, the adhesive mixed in the powder will be carbonized, and the insulation of the material will be reduced, affecting the product performance.

As can be seen from the comparison of Example 1 and Comparative Examples 1-2, the main advantages of the inductive component in the present application are: 1. the DC impedance value of the product is reduced and the working current of the product is increased; 2. the problem of interlayer short circuits in one-piece pressed inductive products is significantly reduced; and 3. especially, this process significantly relieves the difficulty of producing small-sized inductive component.

The applicant declares that the above are only specific embodiments of the present application, and the protection scope of the present application is not limited thereto. It should be understood by those skilled in the art that any change or replacement that are obvious to a person skilled in the art within the technical scope disclosed by the present application shall fall within the scope of protection and disclosure of the present application.

What is claimed is:

1. A preparation method for an inductive component, comprising:
(1) mixing and granulating a first magnetic alloy powder, a second magnetic alloy powder, and a binder, and then performing pressing, and baking and curing the pressed blank to obtain a magnetic central core;
(2) combining the magnetic central core obtained in step (1) with a coil and placing into a mold cavity, injecting a cladding powder slurry, and then baking to obtain a semi-finished component; and
(3) coating an insulation layer on the surface of the semi-finished component obtained in step (2), performing paint stripping, and then performing electroplating to form an electrode layer to obtain the inductive component.

2. The preparation method according to claim 1, wherein the first magnetic alloy powder in step (1) comprises an amorphous alloy powder and/or a nanocrystalline powder.

3. The preparation method according to claim 1, wherein a median particle size D50 of the first magnetic alloy powder is 20-40 μm.

4. The preparation method according to claim 1, wherein the second magnetic alloy powder comprises any one or a combination of at least two of an iron-nickel powder, an iron-silicon-aluminum powder, or an iron-silicon-chromium powder.

5. The preparation method according to claim 1, wherein a median particle size D50 of the second magnetic alloy powder is 1-5 μm;
preferably, a gradation ratio of the first magnetic alloy powder and the second magnetic alloy powder is 2:8-8:2;
preferably, the binder comprises an epoxy adhesive;
preferably, a total mass of the first magnetic alloy powder and the second magnetic alloy powder and a mass of the binder have a ratio of 100:1-3.5.

6. The preparation method according to claim 1, wherein a mesh number for the mixing and granulating in step (1) is 60-250;
preferably, a pressure of the pressing is 3-10 T/cm²;
preferably, a temperature of the pressing is 20-200° C.;
preferably, a time of the pressing is 1-180 s.

7. The preparation method according to claim 1, wherein an atmosphere for the baking and curing in step (1) comprises an inert atmosphere;
preferably, a heating method of the baking and curing is stepped heating;
the stepped heating comprises one-step heating, two-step heating, three-step heating, and four-step heating;
preferably, a temperature after the one-step heating is 90-110° C.;
preferably, an insulation time after the one-step heating is 20-40 min;
preferably, a temperature after the two-step heating is 120-150° C.;
preferably, an insulation time after the two-step heating is 20-40 min;
preferably, a temperature after the three-step heating is 180-200° C.;
preferably, an insulation time after the three-step heating is 50-70 min;
preferably, a temperature after the four-step heating is 350-380° C.;
preferably, an insulation time after the four-step heating is 100-140 min;
preferably, a shape of the magnetic central core comprises a circular shape, an elliptical shape, a square shape, a conical shape, an I-shape, or a T-shape;
preferably, a fitting gap of 0.02-0.06 mm is reserved for the magnetic central core.

8. The preparation method according to claim 1, wherein a material of the coil in step (2) comprises a conductive material and an insulation layer and a self-adhesive layer arranged on the surface of the conductive material;
preferably, the conductive material comprises copper;
preferably, the coil comprises any one or a combination of at least two of a circular wire, a flat wire, or a square corner wire.

9. The preparation method according to claim 1, wherein the cladding powder slurry in step (2) comprises a third magnetic alloy powder, a fourth magnetic alloy powder, a dispersant, a consumable agent, an accelerator, and an organic solvent;
preferably, the third magnetic alloy powder comprises an amorphous alloy powder and/or a nanocrystalline powder;
preferably, a median particle size D50 of the third magnetic alloy powder is 20-55 μm;
preferably, the fourth magnetic alloy powder comprises any one or a combination of at least two of an iron-nickel powder, an iron-silicon-aluminum powder, or an iron-silicon-chromium powder;
preferably, a median particle size D50 of the fourth magnetic alloy powder is 0.3-0.8 μm;
preferably, a gradation ratio of the third magnetic alloy powder and the fourth magnetic alloy powder is 2:8-8:2;
preferably, the organic solvent comprises alcohol and/or toluene;
preferably, a viscosity of the cladding powder slurry is 500-2000 Mpa·s;
preferably, an injection pressure per unit area of the injecting the cladding powder slurry is less than or equal to 0.5 T/cm².

10. The preparation method according to claim 1, wherein a heating method for the baking in step (2) is stepped heating;
the stepped heating comprises one-step heating, two-step heating, and three-step heating;
preferably, a temperature after the one-step heating is 90-110° C.;
preferably, an insulation time after the one-step heating is 20-40 min;
preferably, a temperature after the two-step heating is 120-150° C.;
preferably, an insulation time after the two-step heating is 20-40 min;
preferably, a temperature after the three-step heating is 180-200° C.;
preferably, an insulation time after the three-step heating is 150-200 min.

11. The preparation method according to claim 1, wherein a material of the insulation layer in step (3) comprises any one or a combination of at least two of an epoxy resin, polyurethane, a silicone resin, an organosilicone resin, an amino resin, a polyimide resin, a phenolic resin, a cyanate resin or an acrylic resin;
preferably, a material of the electroplating comprises any one or a combination of at least two of copper, nickel, or tin.

12. An inductive component, wherein the inductive component is prepared by the method according to claim 1.

13. (canceled)

14. A preparation method for lightweight intelligent mobile terminals, which uses the inductive component according to claim 12.
